(19) United States
(12) Patent Application Publication
(10) Pub. No.: US 2026/0357880 A1
(43) Pub. Date: Nov. 12, 2026

(54) TRANSMISSION DEVICE

(71) Applicant: MUSASHI SEIMITSU INDUSTRY CO., LTD., TOYOHASHI-SHI, AICHI (JP)

(72) Inventor: Keisuke ISHIKAWA, TOYOHASHI-SHI, AICHI (JP)

(21) Appl. No.: 19/488,366

(22) PCT Filed: May 29, 2023
(86) PCT No.: PCT/JP2023/019935

§ 371 Date: Nov. 26, 2025

(51) Int. Cl. F16H 37/08; F16H 48/06; F16H 57/037; F16H 57/04

(52) U.S. Cl. CPC F16H 37/0806; F16H 48/06; F16H 57/037; F16H 57/0424; F16H 57/0471

(57) ABSTRACT

Provided is a transmission device that can lubricate a bearing while suppressing an increase in size of a gear case. One aspect of the present disclosure is a transmission device including: a transmission mechanism; and a gear case accommodating the transmission mechanism therein. The gear case includes: a recess recessed outward of the gear case; and an oil-capturing part provided radially outside a ring gear when viewed in an axial direction of the ring gear. The recess and the oil-capturing part are positioned above a rotation axis of the ring gear. The oil-capturing part is positioned forward of the recess in a reference rotation direction of the ring gear.

### TECHNICAL FIELD

The present disclosure relates to a transmission device.

### BACKGROUND ART

In a transmission device including gears, a structure is known in which bearing lubrication oil scraped up by the gears is supplied from a reservoir located above the gears to bearings on both axial sides of the gears (see Patent Document 1).

### PRIOR ART DOCUMENTS

### Patent Documents

Patent Document 1: Japanese Unexamined Patent Application Publication No. 2016-008646

### SUMMARY OF THE INVENTION

### Problems to be Solved by the Invention

In the aforementioned transmission device, the reservoir is located above the gears, so that the size of a gear case increases in its up-down direction.

One aspect of the present disclosure preferably provides a transmission device that can lubricate a bearing while suppressing an increase in size of a gear case.

### Means for Solving the Problems

One aspect of the present disclosure is a transmission device comprising; a transmission mechanism; and a gear case accommodating the transmission mechanism therein. The transmission mechanism includes: an input gear; a counter gear having a rotation axis parallel to a rotation axis of the input gear; a ring gear having a rotation axis parallel to the rotation axis of the input gear; a differential case fixed to the ring gear; a differential mechanism disposed inside the differential case; an input gear bearing rotatably supporting the input gear; a counter gear bearing rotatably supporting the counter gear; a first differential case bearing rotatably supporting the differential case; and a second differential case bearing rotatably supporting the differential case and disposed opposite the first differential case bearing across the ring gear in an axial direction of the ring gear.

The counter gear includes: a first gear meshing with the input gear; and a second gear having an outer diameter smaller than the first gear, disposed concentrically with the first gear, and meshing with the ring gear. The gear case includes a first case and a second case holding the transmission mechanism therebetween in an axial direction of the input gear. The first differential case bearing is attached to the first case.

The first case includes: a recess provided in a region of an inner surface of the first case and recessed outward of the first case in the axial direction of the ring gear, the region facing the ring gear in the axial direction of the ring gear; a first differential case flow path that for supplying oil from the recess to the first differential case bearing; an oil-capturing part provided radially outside the ring gear when viewed in the axial direction of the ring gear; and a supply rib protruding from the inner surface of the first case in the axial direction of the ring gear, for supplying the oil from the oil-capturing part to the second case.

The ring gear is a helical gear having a helix angle such that the oil is conveyed toward the inner surface of the first case when the ring gear rotates in a reference rotation direction. The recess and the oil-capturing part are positioned above the rotation axis of the ring gear. The oil-capturing part is positioned forward of the recess in the reference rotation direction.

According to this configuration, oil is supplied toward the first case from the recess that is provided on a part axially overlapping the ring gear, so that it is possible to suppress an increase in size of the gear case in its up-down direction. In addition, when the ring gear rotates in the reference rotation direction for conveying oil toward the first case, oil is delivered to the recess before reaching the oil-capturing part that supplies oil toward the second case, so that it is possible to suppress a shortage of the amount of oil supplied toward the first case (i.e., to the first differential case bearing).

In one aspect of the present disclosure, the second differential case bearing may be attached to the second case. The second case may include a second differential case flow path for supplying oil from the supply rib to the second differential case bearing. According to this configuration, the lubrication of the second differential case bearing can be improved.

In one aspect of the present disclosure, the rotation axis of the counter gear may be located above the rotation axis of the input gear and the rotation axis of the ring gear. Of the first case and the second case, a case facing the first gear in the axial direction of the counter gear may include an input gear flow path for supplying oil scraped up by the first gear to the input gear bearing. According to this configuration, it is possible to supply oil, on a side surface of the counter gear, to the input gear bearing. Therefore, by arranging the counter gear upward, an increase in size of the gear case in the up-down direction can be suppressed while reducing the churning resistance of the counter gear.

In one aspect of the present disclosure, the first gear may be a helical gear having a helix angle such that oil is conveyed toward the input gear flow path when the ring gear rotates in the reference rotation direction. According to this configuration, the amount of oil supplied to the input gear bearing can be increased.

In one aspect of the present disclosure, the gear case may include a reservoir rib facing the counter gear from a radially outside of the counter gear at a position lower than the rotation axis of the counter gear. According to this configuration, the amount of oil scraped up by the counter gear can be increased while reducing the churning resistance of the counter gear.

### BRIEF DESCRIPTION OF THE DRAWINGS

FIG. 1 is an example of installation of a first transmission device in a vehicle in an embodiment.

FIG. 2 is a schematic left side view of the first transmission device in FIG. 1 with a right case and a part of a bearing removed.

FIG. 3 is a schematic cross-sectional view taken along line III-III in FIG. 2.

FIG. 4 is a schematic right side view of the first transmission device in FIG. 2 with a left case and the part of the bearing removed.

FIG. 5 is a schematic left side view of the left case in FIG. 2.

FIG. 6 is a schematic right side view of the right case in FIG. 4.

FIG. 7 is a schematic left side view of the left case in FIG. 2.

FIG. 8 is a schematic right side view of the right case in FIG. 4.

FIG. 9 is an example of installation of a second transmission device in a vehicle in an embodiment.

### EXPLANATION OF REFERENCE NUMERALS

1A, 1B . . . transmission device, 2 . . . transmission mechanism, 3 . . . gear case, 3A ... left case, 3B . . . right case, 21 . . . input gear, 22 . . . counter gear, 23 . . . ring gear, 24 . . . differential case, 25 . . . differential mechanism, 27A, 27B . . . input gear bearing, 28A, 28B . . . counter gear bearing, 29A, 29B . . . differential case bearing, 31 . . . catch tank, 32 . . . oil-capturing part, 33A, 33B . . . supply rib, 34A, 34B . . . recess, 35A, 35B . . . differential case flow path, 36A, 36B . . . input gear flow path, 37A, 37B . . . auxiliary flow path, 38A, 38B . . . guide portion, 39A, 39B . . . reservoir rib, 221 . . . first gear, 222 . . . second gear, 241 . . . differential mechanism housing portion

### MODE FOR CARRYING OUT THE INVENTION

Hereinafter, descriptions will be given of embodiments to which the present disclosure is applied, with reference to drawings.

### 1. First Embodiment

### 1-1. Configuration

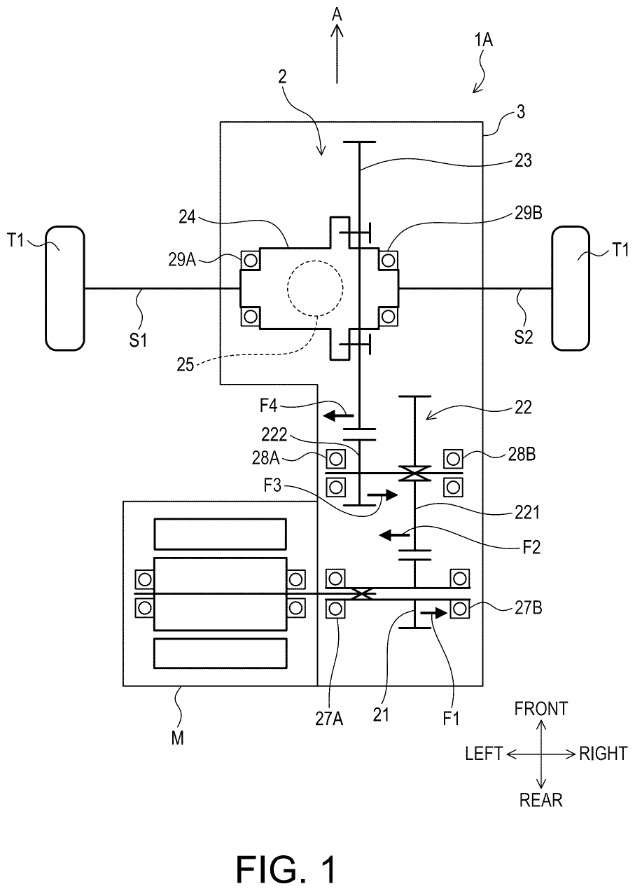

A first transmission device 1A shown in FIG. 1 is a device that is installed in a vehicle and that transmits power from a drive source of the vehicle (that is, a motor M) to wheels.

The first transmission device 1A is used for a vehicle with an RR-type (Rear-engine, Rear-drive) layout. Specifically, the first transmission device 1A is configured to rotate rear wheels TI that are arranged forward of the motor M along a forward direction A of the vehicle.

The first transmission device 1A comprises a transmission mechanism 2 and a gear case 3. The first transmission device 1A is installed in a RR-type vehicle such that a direction parallel to a rotation axis L1 of an input gear 21 of the transmission mechanism 2 extends along the right-left direction, and the input gear 21 is positioned rearward relative to the ring gear 23.

### Transmission Mechanism

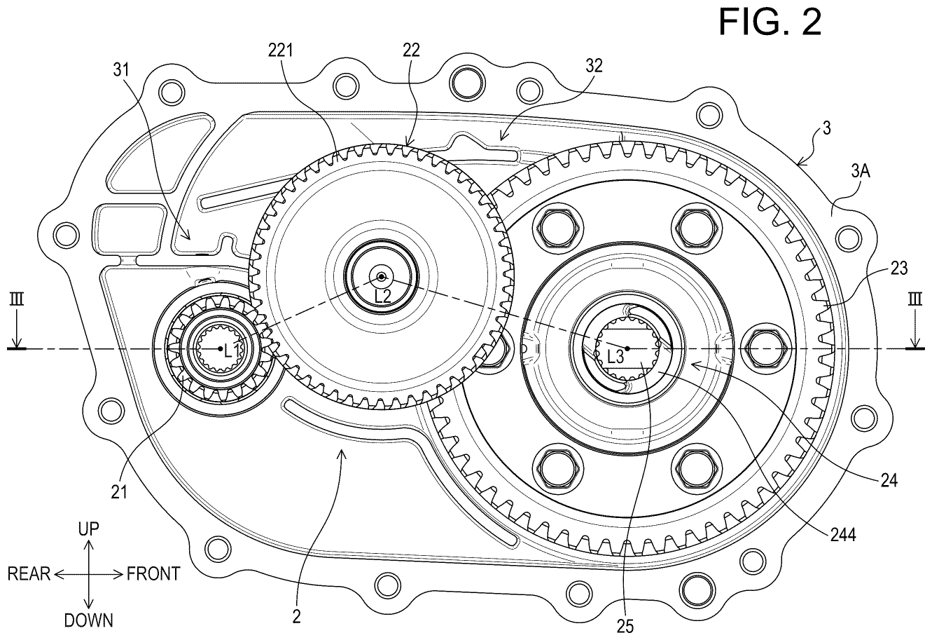

As shown in FIG. 2, the transmission mechanism 2 includes the input gear 21, a counter gear 22, a ring gear 23, a differential case 24, and a differential mechanism 25.

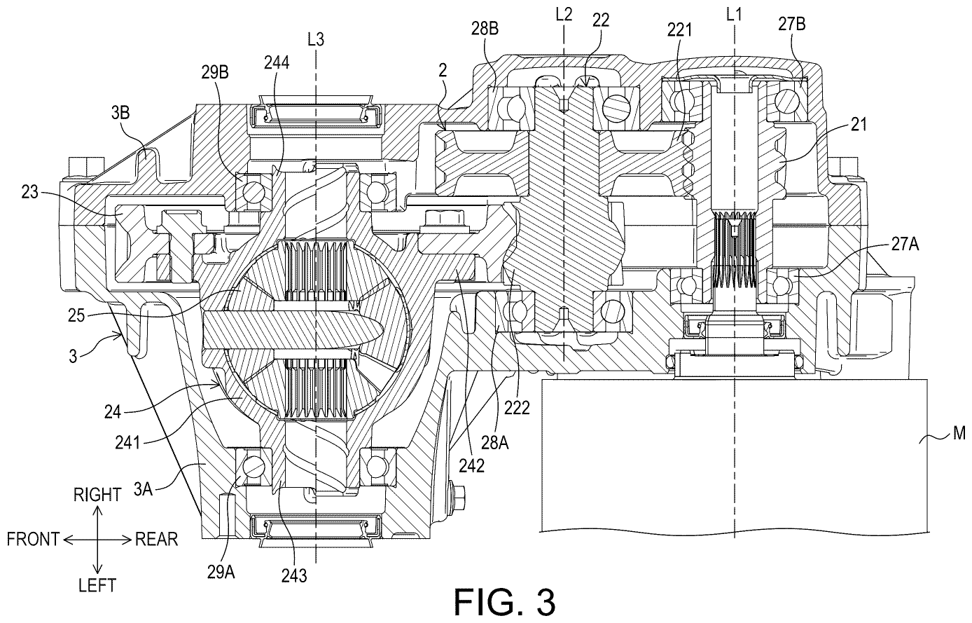

In addition, as shown in FIG. 3, the transmission mechanism 2 includes a left input gear bearing 27A, a right input gear bearing 27B, a left counter gear bearing 28A, a right counter gear bearing 28B, a left differential case bearing 29A, and a right differential case bearing 29B.

### Input Gear

The input gear 21 is an external gear that is drivingly coupled to the motor M to thereby axially rotate by a driving force of the motor M.

The input gear 21 rotates clockwise in FIG. 2 when the vehicle moves forward, and rotates counterclockwise in FIG. 2 when the vehicle moves backward. The rotation axis L1 of the input gear 21 is parallel to the right-left direction.

The input gear 21 is a left-hand helical gear. A thrust load F1 in a right direction is generated in the input gear 21 when the vehicle moves forward (see FIG. 1).

### Counter Gear

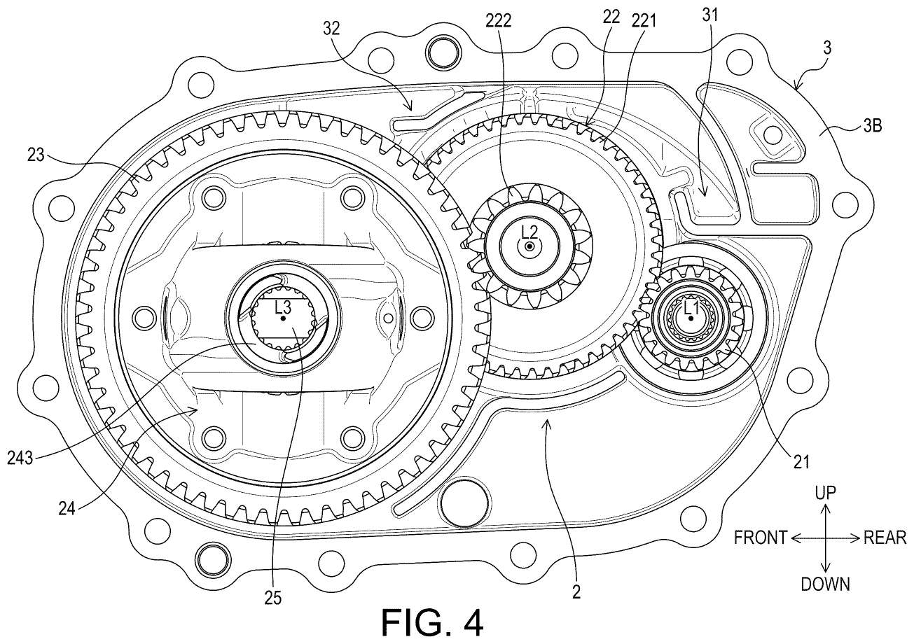

The counter gear 22 shown in FIG. 4 has a rotation axis L2 parallel to the rotation axis L1 of the input gear 21.

The rotation axis L2 of the counter gear 22 is located forward of the rotation axis L1 of the input gear 21 and located above the rotation axis LI of the input gear 21 and a rotation axis L3 of the ring gear 23. The counter gear 22 includes a first gear 221 and a second gear 222.

The first gear 221 is an external gear that meshes with the input gear 21. The first gear 221 is a right-hand helical gear. A thrust load F2 in a left direction is generated in the first gear 221 when the vehicle moves forward (see FIG. 1).

The first gear 221 has a helix angle such that oil is conveyed toward a right input gear flow path 36B in a right case 3B (that is, in the right direction) when the ring gear 23 rotates in a reference rotation direction.

In the present embodiment, the “reference rotation direction” of the ring gear 23 refers to a rotation direction of the ring gear 23 when the vehicle moves backward (specifically, a rotation direction of the ring gear 23 to convey oil to the right), which is a counterclockwise direction in FIG. 2.

As shown in FIG. 3, the second gear 222 is an external gear that meshes with the ring gear 23. The second gear 222 has an outer diameter smaller than the first gear 221 and is arranged concentrically with the first gear 221. The second gear 222 is located on the left side of the first gear 221.

The second gear 222 is a right-hand helical gear. In other words, the helix direction of the first gear 221 and the helix direction of the second gear 222 are the same with each other. The second gear 222 rotates together with the first gear 221. A thrust load F3 in the right direction is generated in the second gear 222 when the vehicle moves forward (see FIG. 1).

### Ring Gear

The ring gear 23 is an external gear having a rotation axis L3 parallel to the rotation axis L1 of the input gear 21. The rotation axis L3 of the ring gear 23 is located forward of the rotation axis L2 of the counter gear 22.

The ring gear 23 rotates the differential case 24 by a rotational force transmitted from the counter gear 22 and scrapes up lubrication oil accumulated in a bottom of the gear case 3.

The ring gear 23 is a left-hand helical gear. A thrust load F4 in the left direction is generated in the ring gear 23 when the vehicle moves forward (see FIG. 1). The ring gear 23 has a helix angle such that oil is conveyed toward an inner surface of a left case 3A (that is, in the left direction) when the ring gear 23 rotates in a non-reference rotation direction (that is, a direction opposite the reference rotation direction). In other words, the ring gear 23 has the helix angle such that oil is conveyed toward an inner surface of the right case 3B (that is, in the right direction) when the ring gear 23 rotates in the reference rotation direction.

### Differential Case

The differential case 24 is fixed to the ring gear 23 and rotates about the rotation axis L3 of the ring gear 23 together with the ring gear 23. As shown in FIG. 3, the differential case 24 includes a differential mechanism housing portion 241, a flange portion 242, a first sleeve 243, and a second sleeve 244.

The differential mechanism housing portion 241 accommodates the differential mechanism 25 therein. The flange portion 242 protrudes radially outward from the differential mechanism housing portion 241. The ring gear 23 is fixed to the flange portion 242.

The first sleeve 243 is a cylindrical portion through which a first output shaft S1 (see FIG. 1) coupled to the differential mechanism 25 is inserted. The second sleeve 244 is a cylindrical portion through which a second output shaft S2 (see FIG. 1) coupled to the differential mechanism 25 is inserted.

### Differential Mechanism

The differential mechanism 25 is a known mechanism that distributes the rotation of the differential case 24 to the first output shaft S1 and the second output shaft S2 while causing the first output shaft SI and the second output shaft S2 to rotate differentially. The differential mechanism 25 is arranged inside the differential mechanism housing portion 241.

The differential mechanism 25 includes: two side gears coupled to the first output shaft S1 and the second output shaft S2, respectively; and two pinion gears that transmit the rotation of the differential case 24 to the two side gears.

The rotation axes of the first output shaft SI and the second output shaft S2 coincide with the rotation axis L3 of the ring gear 23. The first output shaft S1 and the second output shaft S2 rotate in accordance with the rotation direction of the input gear 21 (that is, a rotation direction of the differential case 24) while rotating differentially.

### Input Gear Bearing

The left input gear bearing 27A and the right input gear bearing 27B shown in FIG. 3 are ball bearings that rotatably support the input gear 21.

The right input gear bearing 27B is disposed opposite the left input gear bearing 27A across teeth of the input gear 21 in the axial direction of the input gear 21. Specifically, the left input gear bearing 27A supports a left end portion of a shaft of the input gear 21, and the right input gear bearing 27B supports a right end portion of the shaft of the input gear 21.

In addition, the left input gear bearing 27A is attached to the left case 3A, The right input gear bearing 27B is attached to the right case 3B.

### Counter Gear Bearing

The left counter gear bearing 28A and the right counter gear bearing 28B are ball bearings that rotatably support the counter gear 22.

The right counter gear bearing 28B is disposed opposite the left counter gear bearing 28A across the first gear 221 and the second gear 222 in the axial direction of the counter gear 22. Specifically, the left counter gear bearing 28A supports a left end portion of a shaft of the counter gear 22, and the right counter gear bearing 28B supports a right end portion of the shaft of the counter gear 22.

In addition, the left counter gear bearing 28A is attached to the left case 3A. The right counter gear bearing 28B is attached to the right case 3B.

### Differential Case Bearing

The left differential case bearing 29A and the right differential case bearing 29B are ball bearings that rotatably support the differential case 24.

The right differential case bearing 29B is disposed opposite the left differential case bearing 29A across the ring gear 23 in the axial direction of the ring gear 23. Specifically, the left differential case bearing 29A supports the first sleeve 243 of the differential case 24, and the right differential case bearing 29B supports the second sleeve 244 of the differential case 24.

In addition, the left differential case bearing 29A is attached to the left case 3A. The right differential case bearing 29B is attached to the right case 3B.

### Gear Case

The gear case 3 accommodates the transmission mechanism 2 therein. The gear case 3 includes the left case 3A (one example of a second case) and the right case 3B (one example of a first case) that hold the transmission mechanism 2 therebetween in the axial direction of the input gear 21 (that is, the right-left direction). The left case 3A and the right case 3B are coupled to each other by two or more bolts to thereby form an accommodating space for accommodating the transmission mechanism 2 and oil.

In addition, the gear case 3 is configured with oil flow paths capable of supplying oil within the gear case 3 to each bearing and oil seals, regardless of the rotation direction of the ring gear 23.

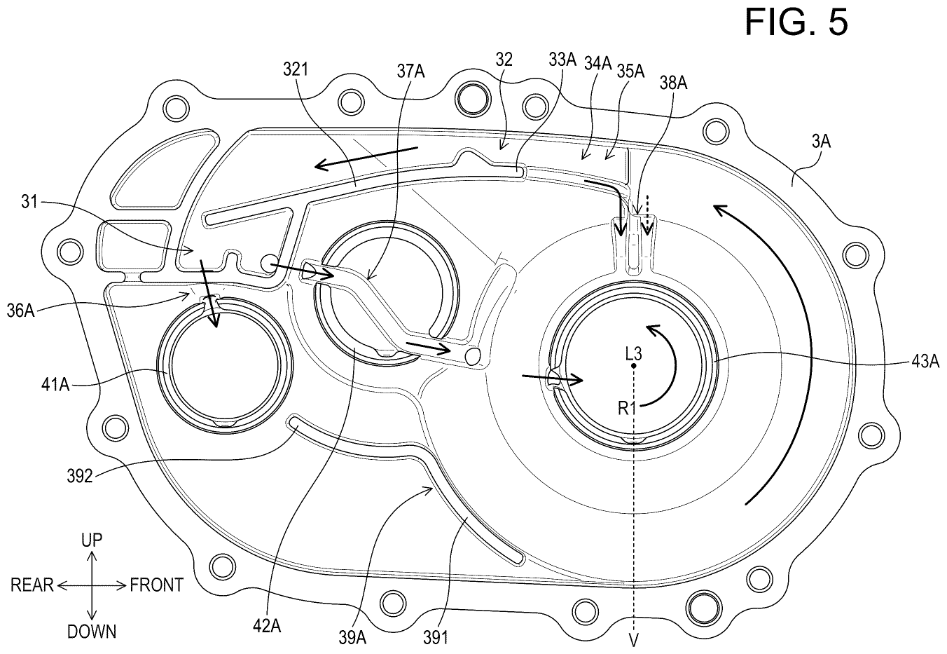

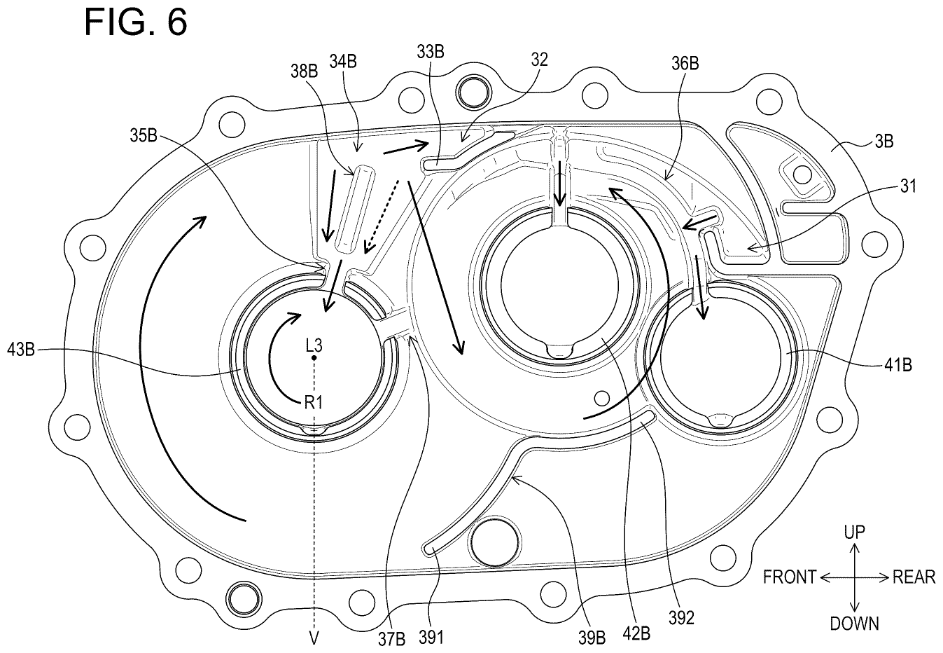

Specifically, as shown in FIGS. 5 and 6, the gear case 3 includes a catch tank 31, an oil-capturing part 32, a left supply rib 33A, a right supply rib 33B, a left recess 34A, a right recess 34B, a left differential case flow path 35A (one example of a second differential case flow path), a right differential case flow path 35B (one example of a first differential case flow path), a left input gear flow path 36A, a right input gear flow path 36B, a left auxiliary flow path 37A, a right auxiliary flow path 37B, a left guide portion 38A, a right guide portion 38B, a left reservoir rib 39A, a right reservoir rib 39B, a left input gear bearing housing portion 41A, a right input gear bearing housing portion 41B, a left counter gear bearing housing portion 42A, a right counter gear bearing housing portion 42B, a left differential case bearing housing portion 43A, and a right differential case bearing housing portion 43B,

### Catch Tank

The catch tank 31 is a portion that stores oil scraped up by the ring gear 23. The catch tank 31 is defined by a rib protruding from the inner surface of the left case 3A toward the right case 3B (that is, protruding rightward) and a rib protruding from the inner surface of the right case 3B toward the left case 3A (that is, protruding leftward). Therefore, the catch tank 31 is provided spanning the left case 3A and the right case 3B.

As shown in FIG. 4, the catch tank 31 is arranged rearward of the counter gear 22 and at a position higher than the input gear 21. In addition, the catch tank 31 is arranged in a position overlying the input gear 21.

### Oil-Capturing Part

The oil-capturing part 32 is provided radially outside of the ring gear 23 when viewed in the axial direction of the ring gear 23. The oil-capturing part 32 is a space for capturing oil scraped up by the ring gear 23.

The oil-capturing part 32 is defined by a rib protruding from the inner surface of the left case 3A toward the right case 3B (that is, protruding rightward) and a rib protruding from the inner surface of the right case 3B toward the left case 3A (that is, protruding leftward). Therefore, the oil-capturing part 32 is provided spanning the left case 3A and the right case 3B.

The oil-capturing part 32 is arranged between the rotation axis L3 of the ring gear 23 and the rotation axis L2 of the counter gear 22 in the front-rear direction. In addition, the oil-capturing part 32 is positioned above the rotation axis L3 of the ring gear 23 and overlies the ring gear 23 and the counter gear 22.

The oil-capturing part 32 is positioned forward of and above the catch tank 31. As shown in FIG. 5, the oil that has passed through the oil-capturing part 32 is delivered to the catch tank 31 by a guide rib 321. Specifically, the guide rib 321 guides oil scraped up by the ring gear 23 to the catch tank 31. In the inner surface of the left case 3A, the guide rib 321 is arranged above the left counter gear bearing housing portion 42A.

### Supply Rib

The left supply rib 33A shown in FIG. 5 protrudes from the inner surface of the left case 3A toward the right case 3B. The left supply rib 33A is provided forward of a rib that defines the oil-capturing part 32 in the left case 3A and is continuous with this rib.

The right supply rib 33B shown in FIG. 6 protrudes from the inner surface of the right case 3B toward the left case 3A so as to abut against the left supply rib 33A. The right supply rib 33B is provided forward of a rib that defines the oil-capturing part 32 in the right case 3B and is continuous with this rib.

The left supply rib 33A and the right supply rib 33B supply oil from the oil-capturing part 32 toward the right case 3B or the left case 3A. Specifically, oil captured in a region, of the oil-capturing part 32, within the left case 3A is delivered from the left supply rib 33A to the right supply rib 33B, thereby being received inside the right case 3B. Oil captured in a region, of the oil-capturing part 32, within the right case 3B is delivered from the right supply rib 33B to the left supply rib 33A, thereby being received inside the left case 3A.

### Recess

The left recess 34A shown in FIG. 5 is a portion that is provided in a region, of the inner surface of the left case 3A, facing the ring gear 23 in the axial direction of the ring gear 23, and that is recessed outward of the left case 3A in the axial direction of the ring gear 23. The left recess 34A is positioned above the rotation axis L3 of the ring gear 23.

The right recess 34B shown in FIG. 6 is a portion that is provided in a region, of the inner surface of the right case 3B, facing the ring gear 23 in the axial direction of the ring gear 23, and that is recessed outward of the right case 3B in the axial direction of the ring gear 23. The right recess 34B is positioned above the rotation axis L3 of the ring gear 23.

In addition, in the reference rotation direction R1, the oil-capturing part 32 is positioned forward of the right recess 34B. More specifically, when the right case 3B is viewed in a direction parallel to the axial direction of the ring gear 23, rotating an imaginary straight line V hung from the rotation axis L3 of the ring gear 23 in the reference rotation direction R1 around the rotation axis L3 of the ring gear 23 causes this imaginary straight line V to reach the right recess 34B before reaching the oil-capturing part 32. In other words, oil scraped up by the ring gear 23 when the ring gear 23 rotates in the reference rotation direction R1 is supplied to the right recess 34B before reaching the oil-capturing part 32.

### Differential Case Flow Path

The left differential case flow path 35A shown in FIG. 5 supplies oil from the left supply rib 33A to the left differential case bearing 29A. Specifically, the left differential case flow path 35A is configured with a groove that extends forward from a front end of the left supply rib 33A and that extends toward the left differential case bearing housing portion 43A, in the left case 3A. In addition, the left differential case flow path 35A has a function to supply oil from the left recess 34A to the left differential case bearing 29A.

The right differential case flow path 35B shown in FIG. 6 supplies oil from the right recess 34B to the right differential case bearing 29B. Specifically, the right differential case flow path 35B is configured with a groove that extends from a lower end of the right recess 34B toward the right differential case bearing housing portion 43B, in the right case 3B. In addition, the right differential case flow path 35B has a function to supply oil from the right supply rib 33B to the right differential case bearing 29B.

### Input Gear Flow Path

The left input gear flow path 36A shown in FIG. 5 supplies oil from the catch tank 31 to the left input gear bearing 27A. Specifically, the left input gear flow path 36A is configured with a hole arranged at a position, of a bottom wall of the catch tank 31, overlying the left input gear bearing housing portion 41A.

The right input gear flow path 36B shown in FIG. 6 supplies oil scraped up by the first gear 221 to the right input gear bearing 27B. Specifically, the right input gear flow path 36B is configured with a groove that extends from a region, of the inner surface of the right case 3B (i.e., the case facing the first gear 221), that is located above the right counter gear bearing housing portion 42B and that overlaps the first gear 221 in an axial direction of the first gear 221, to the right input gear bearing housing portion 41B.

### Auxiliary Flow Path

The left auxiliary flow path 37A shown in FIG. 5 supplies oil from the catch tank 31 to the left counter gear bearing 28A and the left differential case bearing 29A. Specifically, the left auxiliary flow path 37A is configured to include: a first tunnel penetrating the catch tank 31 and communicating with the left counter gear bearing housing portion 42A; a groove crossing the left counter gear bearing housing portion 42A; and a second tunnel connecting this groove with the left differential case bearing housing portion 43A.

The right auxiliary flow path 37B shown in FIG. 6 supplies oil scraped up by the first gear 221 to the right differential case bearing 29B without passing through the right recess 34B. Specifically, the right auxiliary flow path 37B is configured with a groove that extends from a region, of the inner surface of the right case 3B, overlapping the first gear 221 in the axial direction of the first gear 221 to the right differential case bearing housing portion 43B.

Oil does not flow through the right auxiliary flow path 37B when the vehicle moves backward (i.e., when the ring gear 23 rotates in the reference rotation direction R1), but flows through the right auxiliary flow path 37B when the vehicle moves forward, as described below.

### Guide Portion

The left guide portion 38A shown in FIG. 5 is a rib defining a part of the left differential case flow path 35A. The left guide portion 38A extends vertically above the rotation axis L3 of the ring gear 23.

Oil flowing from the left recess 34A strikes a rear surface of the left guide portion 38A, thereby being guided to the left differential case bearing housing portion 43A. In addition, part of oil scraped up by the ring gear 23, when rotating in the reference rotation direction R1, strikes a front surface of the left guide portion 38A, thereby being guided to the left differential case bearing housing portion 43A.

The right guide portion 38B shown in FIG. 6 is a rib arranged inside the right recess 34B. The right guide portion 38B extends vertically above the rotation axis L3 of the ring gear 23.

The part of oil scraped up by the ring gear 23, when rotating in the reference rotation direction R1, strikes a front surface of the right guide portion 38B, thereby staying in the right recess 34B and then being guided to the right differential case bearing housing portion 43B. In addition, oil flowing from the oil-capturing part 32 strikes a rear surface of the right guide portion 38B, thereby being guided to the right differential case bearing housing portion 43B.

### Reservoir Rib

The left reservoir rib 39A shown in FIG. 5 is a rib protruding from the inner surface of the left case 3A toward the right case 3B. The right reservoir rib 39B shown in FIG. 6 is a rib protruding from the inner surface of the right case 3B toward the left case 3A so as to abut against the left reservoir rib 39A.

The left reservoir rib 39A and the right reservoir rib 39B each face the counter gear 22 from a radially outside of the counter gear 22 at a position lower than the rotation axis L2 of the counter gear 22. The left reservoir rib 39A and the right reservoir rib 39B each include: a first part 391 that extends along an outer edge of the ring gear 23; and a second part 392 that extends rearward from a rear end of the first part 391. The first part 391 faces a rear lower portion of the ring gear 23. The second part 392 faces a lower portion of the first gear 221. The second part 392 reaches the vicinity of the left input gear bearing housing portion 41A and the right input gear bearing housing portion 41B.

### Bearing Housing Portion

The left input gear bearing housing portion 41A, the left counter gear bearing housing portion 42A, and the left differential case bearing housing portion 43A shown in FIG. 5 accommodate the left input gear bearing 27A, the left counter gear bearing 28A, and the left differential case bearing 29, respectively.

The left input gear bearing housing portion 41A, the left counter gear bearing housing portion 42A, and the left differential case bearing housing portion 43A are recesses provided on the inner surface of the left case 3. The left input gear bearing housing portion 41A includes an opening through which a motor shaft is inserted. The left differential case bearing housing portion 43A includes an opening through which the first output shaft S1 is inserted. These openings are provided with oil seals.

The right input gear bearing housing portion 41B, the right counter gear bearing housing portion 42B, and the right differential case bearing housing portion 43B shown in FIG. 6 accommodate the right input gear bearing 27B, the right counter gear bearing 28B, and the right differential case bearing 29B, respectively.

The right input gear bearing housing portion 41B, the right counter gear bearing housing portion 42B, and the right differential case bearing housing portion 43B are recesses provided on the inner surface of the right case 3B. The right differential case bearing housing portion 43B includes an opening through which the second output shaft S2 is inserted. This opening is provided with an oil seal.

### Oil Behavior

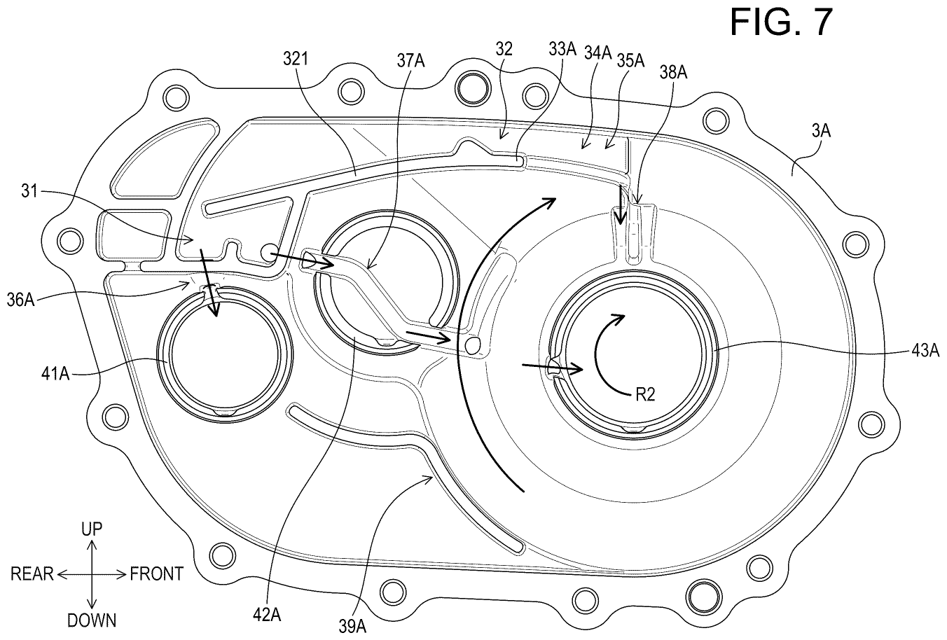

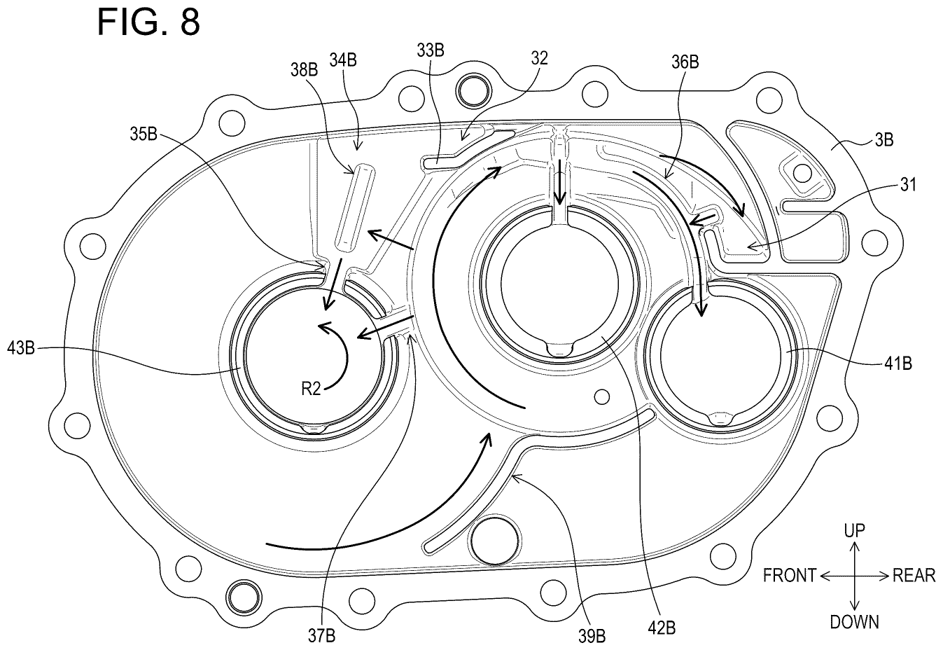

As shown by arrows in FIGS. 7 and 8, when the vehicle moves forward, oil scraped up by the ring gear 23 falls along the left guide portion 38A, thereby being supplied to the left differential case bearing 29A and the oil seal of the left differential case bearing housing portion 43A (FIG. 7). Simultaneously, oil falls along the right guide portion 38B and passes through the right differential case flow path 35B, thereby being supplied to the right differential case bearing 29B and the oil seal of the right differential case bearing housing portion 43B (FIG. 8).

The phrase “when the vehicle moves forward” refers to a case where the ring gear 23 rotates in the non-reference rotation direction R2, which is a clockwise direction in FIG. 7 and is a counterclockwise direction in FIG. 8 (i.e., a direction opposite the reference rotation direction R1).

In addition, as shown in FIG. 8, part of oil scraped up by the ring gear 23 is scraped up further by the first gear 221. This causes oil to be supplied to the right counter gear bearing 28B, the right input gear bearing 27B, and the catch tank 31.

As shown in FIG. 7, oil supplied to the catch tank 31 is supplied to the left input gear bearing 27A, the oil seal of the left input gear bearing housing portion 41A, the left counter gear bearing 28A, and the left differential case bearing 29A through the left input gear flow path 36A and the left auxiliary flow path 37A. In addition, as shown in FIG. 8, oil overflowing from the catch tank 31 is supplied from the right input gear flow path 36B to the right input gear bearing 27B.

As shown by arrows in FIGS. 5 and 6, when the vehicle moves backward, in the left case 3A, the part of oil scraped up by the ring gear 23 passes through the oil-capturing part 32 and is supplied to the catch tank 31 (FIG. 5). Simultaneously, oil is conveyed to the right recess 34B of the right case 3B by the helix angle of the ring gear 23 and falls along the right guide portion 38B, thereby being supplied to the right differential case bearing 29B and the oil seal of the right differential case bearing housing portion 43B. In addition, the part of oil scraped up by the ring gear 23 (specifically, the oil that has passed through the right recess 34B) is also delivered to the oil-capturing part 32 (FIG. 6).

The phrase “when the vehicle moves backward” refers to a case where the ring gear 23 rotates in the reference rotation direction R1, which is a counterclockwise direction in FIG. 5 and a clockwise direction in FIG. 6.

In addition, as shown in FIG. 6, the part of oil scraped up by the ring gear 23 is scraped up further by the first gear 221 and supplied to the right counter gear bearing 28B. At this point in time, oil is conveyed to the right input gear flow path 36B by the helix angle of the first gear 221, and from there oil is also supplied to the right input gear bearing 27B.

As shown in FIG. 5, oil delivered to the catch tank 31 is supplied to the left input gear bearing 27A, the oil seal of the left input gear bearing housing portion 41A, the left counter gear bearing 28A, and the left differential case bearing 29A through the left input gear flow path 36A and the left auxiliary flow path 37A.

Oil supplied to the oil-capturing part 32 in the right case 3B is delivered to the left supply rib 33A of the left case 3A by the right supply rib 33B, and is further supplied to the left differential case bearing 29A and the oil seal of the left differential case bearing housing portion 43A through the left differential case flow path 35A. In addition, as shown in FIG. 6, oil overflowing from the catch tank 31 merges into the right input gear flow path 36B.

In this manner, the gear case 3 includes the oil flow paths that supply oil to the bearings and the oil seals in each of the cases where the ring gear 23 rotates in the reference rotation direction R1 and where the ring gear 23 rotates in the non-reference rotation direction R2.

### 1-2. Effects

The embodiment detailed above achieves the following effects.
(1a) Since oil is supplied toward the right case 3B from the right recess 34B that is provided on a part axially overlapping the ring gear 23, it is possible to suppress an increase in size of the gear case 3 in the up-down direction. In addition, when the ring gear 23 rotates in the reference rotation direction R1 for conveying oil toward the right case 3B, oil is delivered to the right recess 34B before reaching the oil-capturing part 32 that supplies oil toward the left case 3A, so that it is possible to suppress a shortage of the amount of oil supplied toward the right case 3B (i.e., to the right differential case bearing 29B).
(1b) The left differential case flow path 35A, to which oil is supplied from the left supply rib 33A, can improve the lubrication of the left differential case bearing 29A.
(1c) The right input gear flow path 36B allows oil to be supplied, on a side surface of the counter gear 22, to the right input gear bearing 27B. Therefore, by arranging the counter gear 22 upward, it is possible to suppress an increase in size of the gear case 3 in the up-down direction while reducing the churning resistance of the counter gear 22.
(1d) The first gear 221 conveys oil to the right input gear flow path 36B when the ring gear 23 rotates in the reference rotation direction R1, thereby making it possible to increase the amount of oil supplied to the right input gear bearing 27B.
(1e) The left reservoir rib 39A and the right reservoir rib 39B can increase the amount of oil scraped up by the counter gear 22 while reducing the churning resistance of the counter gear 22.

### 2. Second Embodiment

### 2-1. Configuration

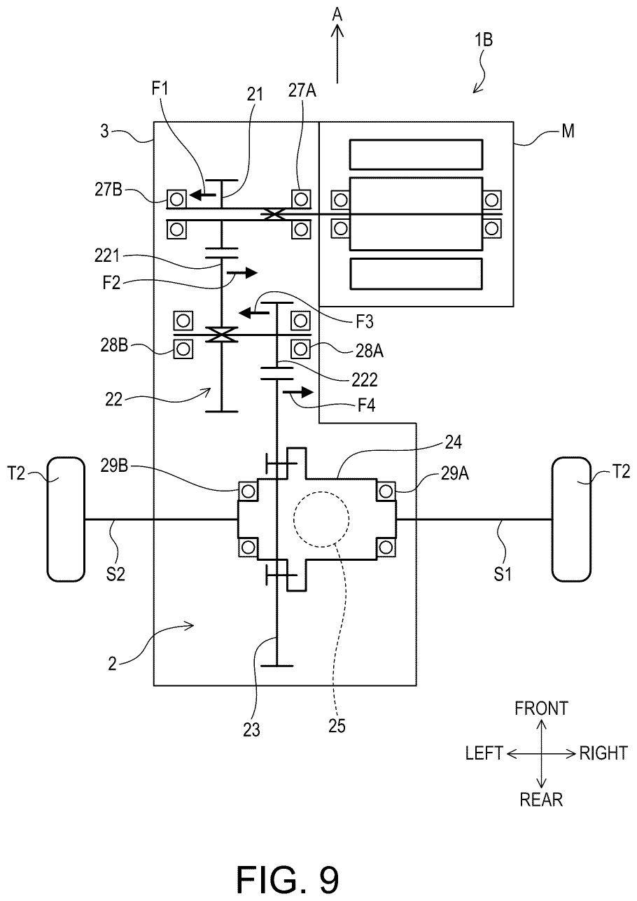

A second transmission device 1B shown in FIG. 9 is a device that is installed in a vehicle and that transmits power from a drive source of the vehicle (that is, a motor M) to wheels.

The second transmission device 1B is used for a vehicle with an MR-type (Midship-engine, Rear-drive) layout or with an FF-type (Front-engine, Front-drive) layout. Specifically, the second transmission device 1B is configured to rotate front wheels (or rear wheels) T2 that are arranged rearward of the motor M along the forward direction A of the vehicle.

The second transmission device 1B comprises the transmission mechanism 2 and the gear case 3. The configuration of the second transmission device 1B (that is, shapes of components) is the same as that of the first transmission device 1A, except for the differences below.

Specifically, in the second transmission device 1B, the helix direction of the input gear 21, the helix direction of the ring gear 23, the helix direction of the first gear 221, and the helix direction of the second gear 222 are reverse to the helix direction of the input gear 21, the helix direction of the ring gear 23, the helix direction of the first gear 221, and the helix direction of the second gear 222 in the first transmission device 1A, respectively.

Accordingly, the input gear 21 in the second transmission device 1B is a right-hand helix. The ring gear 23 in the second transmission device 1B is a right-hand helix. The first gear 221 and second gear 222 in the second transmission device 1B are left-hand helices.

In addition, the second transmission device 1B is installed in the vehicle in a reversed orientation compared to the first transmission device 1A. In other words, the second transmission device 1B is installed in the vehicle rotated 180 degrees relative to the first transmission device 1A as seen in plan view.

This causes the left case 3A of the first transmission device 1A to be arranged on a right side of the second transmission device 1B, and the right case 3B of the first transmission device 1A to be arranged on a left side of the second transmission device 1B. In other words, in the second transmission device 1B, the left case 3A corresponds to a “first case” and the right case 3B corresponds to a “second case”. This is applicable to the left and right bearings of the gears.

When the vehicle moves forward, a rotation direction of each gear of the transmission mechanism 2 of the second transmission device 1B relative to the gear case 3 is reverse to that of the first transmission device 1A. However, as mentioned above, the helix direction of the ring gear 23 of the second transmission device 1B is reverse to the helix direction of the ring gear 23 of the first transmission device 1A, and thus a “reference rotation direction” of the ring gear 23 of the second transmission device 1B is the same as the “reference rotation direction” of the ring gear 23 of the first transmission device 1A.

For this reason, in the second transmission device 1B, the oil behavior shown in FIGS. 5 and 6 occurs when the vehicle moves forward, and the oil behavior shown in FIGS. 7 and 8 occurs when the vehicle moves backward.

Furthermore, in the second transmission device 1B, the ring gear 23 rotates in the reference rotation direction R1 as shown in FIGS. 5 and 6 at a higher speed than that in the first transmission device 1A during the backward movement. Thus, as shown by broken lines in FIG. 5, oil scraped up by the ring gear 23 is supplied directly to the left differential case bearing 29A and the left differential case bearing housing portion 43A by falling. In addition, since the amount of oil supplied to the oil-capturing part 32 increases in the right case 3B, oil is supplied from the oil-capturing part 32 to the right differential case bearing 29B and the right differential case bearing housing portion 43B, as shown by broken lines in FIG. 6.

In the second transmission device 1B, oil is conveyed to the left recess 34A by the helix of the ring gear 23. As shown in FIG. 5, in the reference rotation direction R1, the oil-capturing part 32 is positioned forward of the left recess 34A, More specifically, when the left case 3A is viewed in a direction parallel to the axial direction of the ring gear 23, rotating the imaginary straight line V hung from the rotation axis L3 of the ring gear 23 in the reference rotation direction R1 around the rotation axis L3 of the ring gear 23 causes this imaginary straight line V to reach the left recess 34A before reaching the oil-capturing part 32. In other words, oil scraped up by the ring gear 23 when the ring gear 23 rotates in the reference rotation direction R1 is supplied to the left recess 34A before reaching the oil-capturing part 32.

### 2-2. Effects

The embodiment detailed above achieves the effects below.
(2a) Since oil is supplied toward the left case 3A from the left recess 34A that is provided on a part axially overlapping the ring gear 23, it is possible to suppress an increase in size of the gear case 3 in the up-down direction. Furthermore, when the ring gear 23 rotates in the reference rotation direction R1 for conveying oil toward the left case 3A, oil is delivered to the left recess 34A before reaching the oil-capturing part 32 that supplies oil toward the right case 3B, so that it is possible to suppress a shortage of the amount of oil supplied toward the left case 3A (i.e., to the left differential case bearing 29A).

### 3. Other Embodiments

Although the embodiments of the present disclosure have been described so far, the present disclosure is not limited to the above-described embodiments and can be implemented in various forms.
(3a) In the transmission devices of the above-described embodiments, the rotation axis of the counter gear does not necessarily have to be located above the rotation axis of the input gear and the rotation axis of the ring gear.
(3b) In the transmission devices of the above-described embodiments, the gear case does not necessarily have to include a reservoir rib.
(3c) The functions of one component in the above-described embodiments may be distributed as two or more components, or the functions of two or more components may be integrated into one component. Part of the configurations of the above-described embodiments may be omitted. At least part of the configurations of the above-described embodiments may be added to or replaced with the configuration of another above-described embodiment. Note that all aspects included in the technical idea specified by the wording recited in the claims are embodiments of the present disclosure.

1. A transmission device comprising:
a transmission mechanism; and
a gear case accommodating the transmission mechanism therein,
the transmission mechanism including:
an input gear having a rotation axis;
a counter gear having a rotation axis parallel to the rotation axis of the input gear;
a ring gear having a rotation axis parallel to the rotation axis of the input gear;
a differential case fixed to the ring gear;
a differential mechanism disposed inside the differential case;
an input gear bearing rotatably supporting the input gear;
a counter gear bearing rotatably supporting the counter gear;
a first differential case bearing rotatably supporting the differential case; and
a second differential case bearing rotatably supporting the differential case and disposed opposite the first differential case bearing across the ring gear in an axial direction of the ring gear,
the counter gear including:
a first gear meshing with the input gear; and
a second gear having an outer diameter smaller than the first gear, disposed concentrically with the first gear, and meshing with the ring gear,
the gear case including a first case and a second case holding the transmission mechanism therebetween in an axial direction of the input gear,
the first differential case bearing being attached to the first case,
the first case including:
a recess provided in a region of an inner surface of the first case and recessed outward of the first case in the axial direction of the ring gear, the region facing the ring gear in the axial direction of the ring gear;
a first differential case flow path configured to supply oil from the recess to the first differential case bearing;
an oil-capturing part provided radially outside the ring gear when viewed in the axial direction of the ring gear; and
a supply rib protruding from the inner surface of the first case in the axial direction of the ring gear and configured to supply the oil from the oil-capturing part toward the second case, wherein:
the ring gear is a helical gear having a helix angle such that the oil is conveyed toward the inner surface of the first case when the ring gear rotates in a reference rotation direction;
the recess and the oil-capturing part are positioned above the rotation axis of the ring gear; and
the oil-capturing part is positioned forward of the recess in the reference rotation direction.

2. The transmission device according to claim 1, wherein:
the second differential case bearing is attached to the second case; and
the second case includes a second differential case flow path configured to supply the oil from the supply rib to the second differential case bearing.

3. The transmission device according to claim 1, wherein:
the rotation axis of the counter gear is located above the rotation axis of the input gear and the rotation axis of the ring gear; and
the first case or the second case faces the first gear in an axial direction of the counter gear and includes an input gear flow path configured to supply the oil scraped up by the first gear to the input gear bearing.

4. The transmission device according to claim 3, wherein
the first gear is a helical gear having a helix angle such that the oil is conveyed toward the input gear flow path when the ring gear rotates in the reference rotation direction.

5. The transmission device according to claim 3, wherein
the gear case includes a reservoir rib facing the counter gear from a radially outside of the counter gear at a position lower than the rotation axis of the counter gear.

6. The transmission device according to claim 2, wherein:
the rotation axis of the counter gear is located above the rotation axis of the input gear and the rotation axis of the ring gear; and
the first case or the second case faces the first gear in an axial direction of the counter gear and includes an input gear flow path configured to supply the oil scraped up by the first gear to the input gear bearing.

7. The transmission device according to claim 6, wherein
the first gear is a helical gear having a helix angle such that the oil is conveyed toward the input gear flow path when the ring gear rotates in the reference rotation direction.

8. The transmission device according to claim 6, wherein
the gear case includes a reservoir rib facing the counter gear from a radially outside of the counter gear at a position lower than the rotation axis of the counter gear.
